(19) United States
(12) Patent Application Publication
(10) Pub. No.: US 2004/0115362 A1
(43) Pub. Date: Jun. 17, 2004

(54) Photocatalytic sputtering targets and methods for the production and use thereof

(76) Inventors: Klause Hartig, Avcoa, WI (US); Annette J. Krisko, Prairie Du Sac, WI (US)

Correspondence Address: FOLEY AND LARDNER, SUITE 500, 3000 K STREET NW, WASHINGTON, DC, 20007, US

(21) Appl. No.: 10/250,687

(22) PCT Filed: Jan. 14, 2002
(86) PCT No.: PCT/EP02/00378

(51) Int. Cl. B32B 17/06; B05D 1/08

(52) U.S. Cl. 427/446; 428/432

(57) ABSTRACT

The invention comprises forming sputtering targets from photocatalyst particles that are free of inert particle treatment. The photocatalyst particles are plasma sprayed onto the target base. For example, a invention comprises plasma dioxide particles onto a target particles are optionally plasma sprayed under conditions that coated with substoichiometric titanium oxide, TiOx, where x is less than 2.

### FIELD OF THE INVENTION

The present invention provides sputtering targets that can be used to deposit thin films and the like. More particularly, this invention provides sputtering targets that can be used to deposit photocatalytic coatings. The invention also provides methods for producing and using targets of this nature, as well as substrates coated by sputtering such targets.

### BACKGROUND OF THE INVENTION

The field of photocatalytic coating technology is founded on the long known ability of certain metal oxides to absorb ultraviolet radiation and photocatalytically degrade organic materials such as oil, plant matter, fats, and greases. The most powerful of these photocatalytic metal oxides appears to be titania. However, other materials are believed to exhibit photoactivity as well. These materials include oxides of iron, silver, copper, tungsten, aluminum, zinc, strontium, palladium, gold, platinum, nickel, and cobalt.

Windows and other glass products would derive great benefit from photocatalytic coatings. For example, such windows would have self-cleaning properties. That is, to the extent organic matter may be deposited on such a window, the photoactive coating would chemically degrade the organic deposits, thereby having a cleaning effect on the surface of the glass. Moreover, to the extent that residue may survive this photocatalysis, such residue would likely be more easily removed by washing or, for outdoor applications, by run-off rainwater. Thus, a self-cleaning, photocatalytic window coating would be very desirable.

The production of windows and other glass products bearing photocatalytic coatings brings a host of new challenges. One significant challenge is the development of commercially feasible methods for applying photocatalytic coatings. Those methods that appear now to be nearing commercial feasibility are primarily wet process applications. For example, compositions containing photocatalyst particles have been spray coated, dip coated, spin coated, and poured onto substrates. Typically, the composition is then made to adhere to the substrate by a high temperature heating process (e.g., sintering).

Wet process applications are less than ideal for coating large area substrates as they typically require two separate processing steps. First, a coating composition is applied to a substrate. Second, the coated substrate is heat treated to adhere the coating to the substrate and to improve crystallinity and, therefore, photocatalytic properties. For example, U.S. Pat. No. 5,874,701, issued to Watanabe et al., the teachings of which are incorporated herein by reference, discloses wet process applications of photocatalytic coatings. Watanabe et al. disclose applying a TiO₂ sol onto a tile substrate and thereafter firing the coated substrate at a high temperature to bond the coating to the substrate. This firing is believed to increase the crystallinity of the coating, thereby enhancing photocatalytic properties. It would be desirable to provide an application method that requires only a single processing step.

In addition to being inefficient from a manufacturing standpoint, wet process applications are not ideal for coating window glass and the like. Coatings applied by wet process methods tend to be relatively thick. Thus, windows bearing these coatings may exhibit undesirably low transmissivity and undesirably high reflectivity. Moreover, the relative thickness of these coatings makes it challenging to engineer a color-neutral window. It is also difficult to deposit highly uniform photocatalytic coatings by wet processes. A window bearing a coating of non-uniform thickness may have an undesirable hazy, irregular appearance. Moreover, slight color variations may be visible as a result of the non-uniform coating thickness. Photocatalytic coatings applied by wet process techniques also tend to be porous. Typically, this causes them to be less durable than equivalent non-porous films. Further, dirt and other contaminants can become encrusted in a porous film. Thus, wet process applications are not ideal for the application of photocatalytic window coatings.

It would be desirable to develop commercially feasible sputtering processes for depositing photocatalytic films. Sputter deposition is fairly conventional in the architectural and automotive glass industries. The process involves use of a sputtering target formed from material that is to be deposited onto a substrate. The target is provided with a negative charge and a relatively positively charged anode is positioned within the sputtering chamber adjacent the target. The chamber is then evacuated. By introducing a small amount of a desired gas into the chamber, a plasma of that gas can be established. Atoms in this plasma collide with the target, knocking material from the target and sputtering it onto the substrate. It is also known in the art to include a magnet behind the target to help shape the plasma and focus the plasma in an area adjacent a desired surface of the target (e.g., the surface of the target that is oriented toward the substrate). This process is generally referred to as magnetron sputtering.

Magnetron sputtering equipment and processes are well known in the art. For example, useful sputtering equipment and processes are disclosed in U.S. Pat. No. 4,166,018 (Chapin) and U.S. Pat. No. 5,645,699 (Sieck), the teachings of each of which are herein incorporated by reference. Magnetron sputtering chambers are commercially available from a variety of sources (e.g., Airco and Leybold).

To be commercially feasible, a sputtered photocatalytic film must meet two basic requirements: it must be sputtered at a very high rate and it must be very thin. For a thin photocatalytic film to be useful, it must be highly efficient. That is, the film must exhibit a significant rate of organic material removal at a minimal thickness. Photocatalytic films must be efficient for a variety of reasons. For example, thin films can be more easily engineered into a film stack without unacceptable changes in reflectivity, transmissivity, and color. Thin films are also relatively inexpensive since they can be sputtered in a short amount of time.

A number of well known materials have been found to exhibit photoactivity. For example, titanium dioxide has been used as a pigment in the paint industry for many years. More recently, it has been determined that titanium dioxide is also a photocatalyst. Titanium dioxide films have been deposited by sputtering. However, they have traditionally been used for purposes other than providing a self-cleaning, photocatalytic coating.

Titanium dioxide has traditionally been sputter deposited by one of two basic methods. First, targets formed of metallic titanium have been sputtered in oxidizing atmospheres. Unfortunately, this process is quite slow. Second, targets formed of titanium dioxide have been sputtered in inert atmospheres. However, titanium dioxide targets suffer from low electrical conductivity. Hence, they are difficult to stably sputter at high power levels. Therefore, titanium dioxide targets have traditionally been limited to low power/low deposition rate sputtering applications.

More recently, it has been discovered that certain titanium oxide targets can be sputtered at very high rates. These targets (which are hereinafter referred to as “HRT targets”) are disclosed in U.S. patent application Ser. Nos. 09/024,071, 09/024,240, 09/044,681, 09/101,405, and 09/589,098, the teachings of each of which are herein incorporated by reference. The HRT targets comprise substoichiometric titanium oxide, TiOₓ, where x is less than two. These targets have high electrical conductivity, allowing them to be sputtered at high rates. Thus, they are ideal for sputtering a wide variety of titania-based films. However, it has not heretofore been known whether these HRT targets could produce significantly photocatalytic films.

Photocatalytic efficiency tests performed on films sputtered from the HRT targets indicate that these films exhibit low levels of photoactivity. In hopes of producing more efficient photocatalytic films, the HRT targets were sputtered under a variety of different process conditions. Ultimately, it was determined that the HRT targets are less than ideal for depositing efficient photocatalytic films.

Those skilled in the art of thin films may not find this terribly surprising. For example, it is known that photoactive films tend to have a crystalline structure. Further, those films that exhibit high levels of photoactivity typically have a crystal structure characterized by large crystals. As is known in the present art, films deposited at high rates tend not to have large crystals. Thus, it would be surprising to achieve a highly photoactive film using any high rate sputtering target.

Surprisingly, the inventors have discovered that the targets of the present invention yield photocatalytic films that are highly efficient. More surprisingly, it has been found that the present targets can be sputtered at very high rates without sacrificing the photocatalytic efficiency of the resulting films. The present targets are believed to be capable of these surprising results as a consequence of the starting materials used in their production.

Contrary to the present targets, the HRT targets are believed to be formed from paint grade titanium dioxide pigment particles. Paint grade titanium dioxide pigments are typically treated in some way to suppress the photoactivity of the pigment, thereby increasing the durability of paints made from such pigment. For example, it has been found that paints made from untreated titanium dioxide particles tend to exhibit “chalking” as a result of the degenerative photocatalytic effects the particles have on paint binder.

The present photocatalytic targets are formed from photocatalyst particles that have not been treated in accordance with the teachings of the paint industry. It has been found that targets formed from untreated particles yield sputtered films that have much higher levels of photoactivity than those sputtered from the HRT targets.

This is surprising because starting materials that are plasma sprayed and then sputtered are reconstituted twice by the time they are ultimately deposited on a substrate. As is well known in the art, materials deposited by plasma spraying or sputtering do not necessarily retain the morphology or chemical properties of the bulk material from which the plasma spraying or sputtering is performed. Thus, it does not naturally follow that targets formed by plasma spraying photocatalytic particles will yield photocatalytic films. To the contrary, it is quite unpredictable. For example, consider that plasma-sprayed material is largely reconstituted during the plasma spraying process. Likewise, during the sputtering process, material is transferred from the target to the substrate on what is essentially an atom-by-atom basis. Thus, the target material is entirely reconstituted during the sputtering process. Moreover, the character of a sputtered film is influenced by a variety of process parameters (e.g., plasma energy, particle resonance times, and substrate temperature). Thus, the morphology and chemical properties of the starting material would not be expected to be carried through both the plasma-spraying and sputtering processes. It is therefore quite surprising that films sputtered from the present targets exhibit such high levels of photoactivity.

### SUMMARY OF THE INVENTION

We have discovered that it is possible to produce sputtering targets that can be used to deposit coatings having surprisingly efficient photocatalytic properties. Specifically, it has been found that targets formed from certain types of photocatalyst particles can be used to sputter deposit such films. We have also discovered that the present targets can be stably sputtered at high power levels, which facilitates high deposition rate sputtering. Thus, the present invention makes possible sputtered films that can be deposited at very high rates and are highly photocatalytic at very small thicknesses.

One aspect of the invention provides a method of producing a sputtering target. The method comprises plasma spraying photocatalyst particles that are free of inert particle treatment onto a target base. In a preferred embodiment, the photocatalyst particles are titanium dioxide particles and the plasma spraying is carried out under conditions that result in the target base being coated with substoichiometric titanium oxide, TiOₓ, where x is less than 2. A further embodiment of the invention provides sputtering targets formed by such methods. Still another embodiment provides a deposition method that comprises sputtering targets of this nature. Yet another embodiment provides a coated substrate produced by sputtering these targets.

### BRIEF DESCRIPTION OF THE DRAWINGS

The invention will now be described into more detail with reference to the accompanying drawings wherein

FIG. 1 is a schematic illustration of a rotatable target in accordance with a particularly preferred embodiment of the present invention;

FIG. 2 is a schematic cross-sectional view of the target illustrated in FIG. 1;

FIG. 3 is a schematic side view of a plasma spraying chamber that can be used in a preferred method of the present invention.

### DESCRIPTION OF THE PREFERRED EMBODIMENTS OF THE INVENTION

There are two basic types of magnetron sputtering targets. Planar targets tend to be relatively large, rectangular plates of sputterable target material. These plates are commonly attached to a conductive backing, which can be electrically connected to a power supply. The backing may also include a cooling system and a magnet used to generate a magnetic field to hold the sputtering plasma in a predefined area. Planar targets are quite well known in the present art.

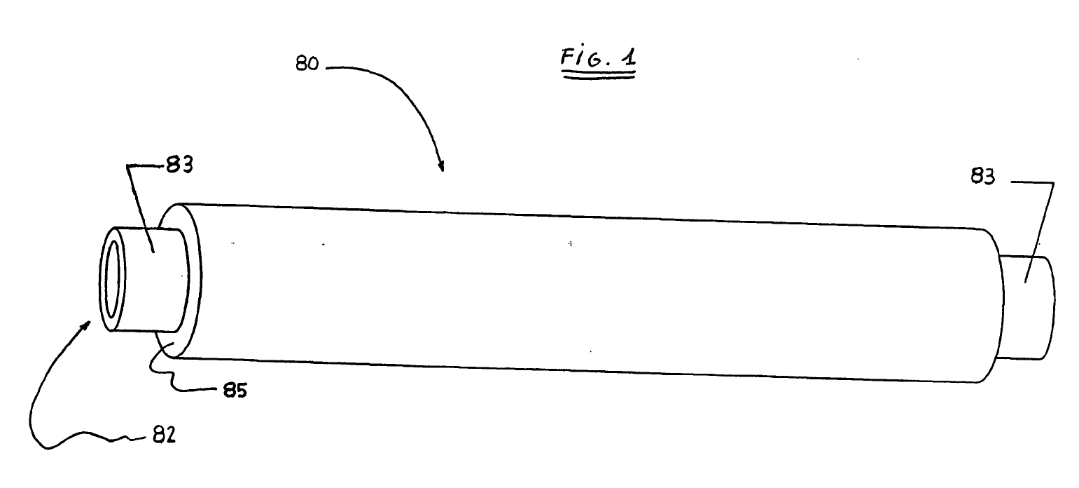

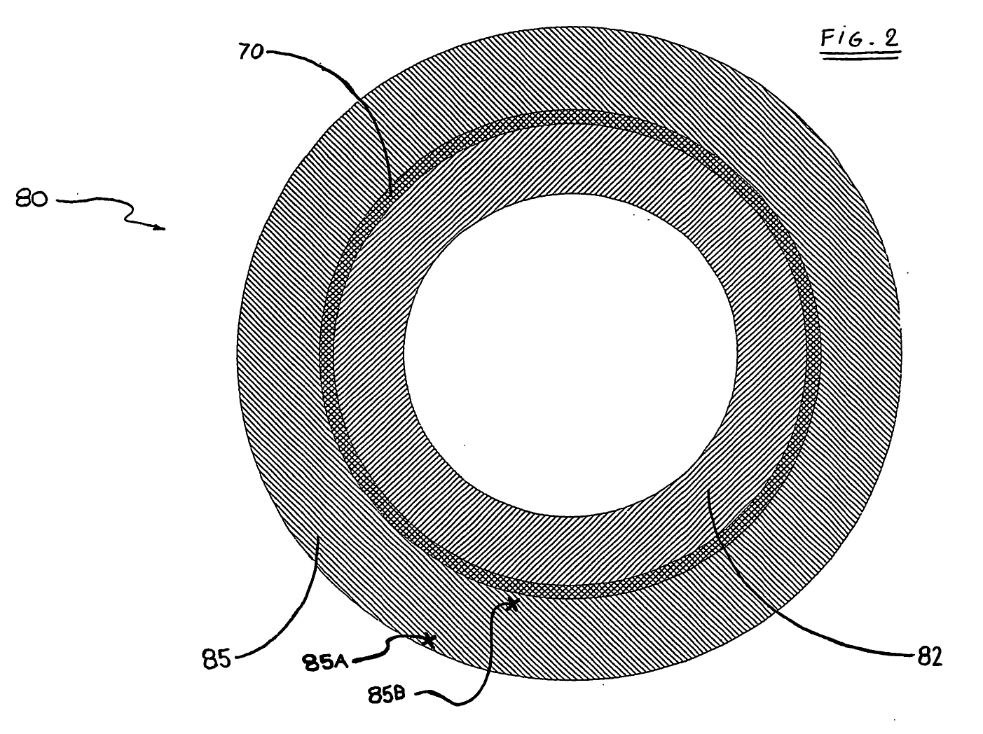

Cylindrical (i.e., rotatable) targets are gaining increased acceptance in the commercial application of thin films. Rotatable targets typically take the form idealized in FIGS. 1 and 2. As shown in FIG. 1, the rotatable target 80 generally includes a conductive backing 82, which is typically in the form of a rigid metal tube. This backing tube is commonly formed of an electrically conductive material. For example, preferred backing materials include aluminum, stainless steel, titanium, and copper. Use of a rigid backing tube allows a magnet to be positioned within the interior of the target, permitting the shape of the charged plasma adjacent the surface of the target to be more carefully controlled.

A layer of sputterable target material 85 is carried on this backing tube 82. The target material 85 may extend laterally from one end of the tube to the other. More commonly, a short length 83 at each end of the backing tube 82 extends laterally beyond the edges of the target material 85 to enable the target 80 to be mounted in a bay of a sputtering chamber. In most commercially available sputtering chambers, the chamber is provided with at least one pair of opposed end blocks, with one end block being used to hold each of the exposed lateral extensions 83 of the backing tube 82. Rotatable targets are also well known in the art.

The target 80 illustrated in FIG. 2 includes a relatively thin bonding layer 70 between the backing tube 82 and the target material 85. If so desired, the target material 85 can be formed directly upon the backing tube 82. However, a bonding layer 70 is advantageous as it helps insure that the target material 85 is securely adhered to the backing tube 82. The bonding layer 70 should be conductive and ideally has a coefficient of thermal expansion between that of the backing tube and the sputterable material. This reduces target degeneration that can occur during heating and cooling as a result of the different thermal expansion rates of the backing tube 82 and the target material 85. Bonding layers of this nature are well known in the art as well.

The inventors have discovered that it is possible to produce sputtering targets that can be used to deposit very efficient photocatalytic films. That is, films that are photocatalytically effective even when very thin. The present targets are sometimes referred to herein as being photocatalytic. It is to be understood that by referring to the targets themselves as being photocatalytic, it is not necessarily represented that the material on each target is itself photoactive (though, this may in fact be the case). Rather, it is meant that such targets can be used to deposit coatings that are photocatalytic. As noted above, coatings deposited by sputtering do not necessarily retain the morphology or chemical properties of the bulk material from which the sputtering is performed. Thus, while it has not been scientifically verified whether the present targets are themselves photocatalytic, films sputtered from these targets have been found to exhibit high levels of photoactivity.

The present targets are formed from photocatalyst particles. As noted above, a number of metal oxides are known photocatalysts. For example, suitable photocatalysts include oxides of a metal selected from the group consisting of titanium, iron, silver, copper, tungsten, aluminum, zinc, strontium, palladium, gold, platinum, nickel, and cobalt. While titanium oxide appears to be the most powerful of these materials, any desired photocatalyst can be used. A variety of alloys are also believed to exhibit photocatalytic properties. Thus, the present targets can be formed from particles comprising any desired photocatalytic material or alloys of different photocatalytic materials.

Using certain types of photocatalyst particles in the formation of sputtering targets has been found to yield targets that are surprisingly photocatalytic. The present targets are formed from photocatalyst particles that are free of inert particle treatment. It is to be understood that use herein of the phrase “inert particle treatment” refers to any process that is intended to suppress the photoactivity of photocatalyst particles. This phrase would include any particle formation process, or subsequent processing, employed to minimize the photoactivity of such particles. For example, it is believed that a variety of surface treatments (e.g., milling and/or coating) may be performed on photocatalyst particles to minimize the photoactivity of the particles.

In one embodiment, the targets are formed from photocatalyst particles that are substantially free of inert coating, that is, any coating that is intended to suppress the photoactivity of the particles. Photocatalyst particles are commonly treated with inorganic coatings that reduce the photoactivity of the particles. For example, titanium dioxide pigment particles are commonly coated with alumina and/or silica to suppress the photoactivity of the pigment (i.e., to render the particles photocatalytically inert). As noted above, these coatings are believed to enhance the durability of paints and other products formed from such pigments. Contrary to the experience of the paint industry, particles bearing inorganic coatings are not believed to be well suited for use in the production of photocatalytic sputtering targets. Thus, in a preferred embodiment, the targets are formed from particles that are substantially free of inorganic coating.

In many cases, it is most favorable to form the present targets from photocatalyst particles that are free of any type of coating. Certain coatings may be used for purposes other than suppressing the photoactivity of the coated particles. For example, the flow characteristics of such particles through a fixed volume (e.g., through the powder supply of a plasma gun) may be enhanced by certain coatings. Generally speaking, though, it is believed to be preferable to form the present targets from uncoated photocatalyst particles. Thus, in a particularly preferred embodiment, the targets are formed from photocatalyst particles that are substantially free of any type of coating (i.e., the exterior surface of each particle is unprotected).

The present targets are desirably formed from high purity photocatalyst particles. Thus, in a particularly preferred embodiment, the targets are formed from photocatalyst particles that have an unmodified crystal lattice. When photocatalytic material (e.g., TiO₂) is used as pigment, the crystal lattice of the material is sometimes modified to create desired pigment properties. For example, the crystal lattice of titanium dioxide may be modified (or “doped”) with aluminum or zinc as inert particle treatment to minimize the photoactivity of the resulting material. That is, aluminum or zinc atoms may be introduced into the crystal lattice of the titanium dioxide. When doped photocatalyst particles are plasma sprayed onto a target base, the dopant may inhibit the growth of large mono-crystals in the resulting target material. Likewise, when targets produced by such plasma spraying methods are sputtered, the dopant may again inhibit large crystal growth in the deposited film. That is, the dopant may act as a crystal growth inhibitor. It is to be understood that use herein of the term “crystal growth inhibitor” refers to any material that inhibits the growth of large crystals. Since it is important to grow large crystals to form efficient photocatalytic films, dopants of this nature are undesirable. Thus, in many cases, it will be preferable to form the present targets from particles of a photocatalyst that has an unmodified crystal lattice.

In other cases, however, it may be desirable to form the present targets from photocatalyst particles that have an intentionally modified crystal lattice. For example, it is anticipated that the introduction of certain dopant atoms into the crystal lattice of a photocatalyst may actually enhance the photoactivity of the material. Thus, another embodiment of the invention involves the plasma spraying of photocatalyst particles that are doped with at least one other material that is intended to enhance the photoactivity of the particles. In this embodiment, of course, the dopant is preferably a material that does not act as a crystal growth inhibitor.

Titanium dioxide is a particularly preferred starting material for the present targets. Titanium dioxide is trimorphous. That is, it exists in three different crystal structures: rutile, anatase, and brookite. The rutile and anatase phases have a tetragonal crystal system and are more easily produced than the brookite phase. Moreover, both of these titanium dioxide phases are known photocatalysts. Thus, the present targets are desirably formed from photocatalyst particles of rutile and/or anatase phase titanium dioxide. Titanium dioxide particles are commercially available from a variety of pigment suppliers. For example, titanium dioxide is sold in both rutile and anatase phases by Kronos, Inc.

In one embodiment of the invention, the targets are formed from uncoated particles of anatase phase titanium dioxide. Uncoated anatase titanium dioxide pigment is sold commercially under the trade name “Kemira AFDC 328”, by Kemira Pigments, Inc. It has been suggested that anatase titanium dioxide exhibits higher levels of photoactivity than rutile titanium dioxide. While this suggestion has apparently not been clearly confirmed, anatase titanium dioxide does have a higher band gap energy (3.2 eV) than the rutile titanium dioxide (3.0 eV). Band gap energy indicates the minimum amount of energy needed for a semiconductor to promote an electron from the valence band to the conduction band. It has been suggested that the higher conduction band energy gives anatase phase TiO₂ just enough oxidizing power to cause the reduction of O₂ (diatomic oxygen) to O₂⁻ (superoxide). Superoxide appears to be important in breaking down organic matter. However, it is not clear that rutile titanium dioxide is not capable of driving this reduction.

In another embodiment of the invention, the targets are formed from a mixture of anatase and rutile titanium dioxide particles. For example, both phases of titanium dioxide pigment can be mixed, milled, and/or ground together into a particulate composition. As noted above, titanium dioxide is sold in both rutile and anatase phases by Kronos, Inc.

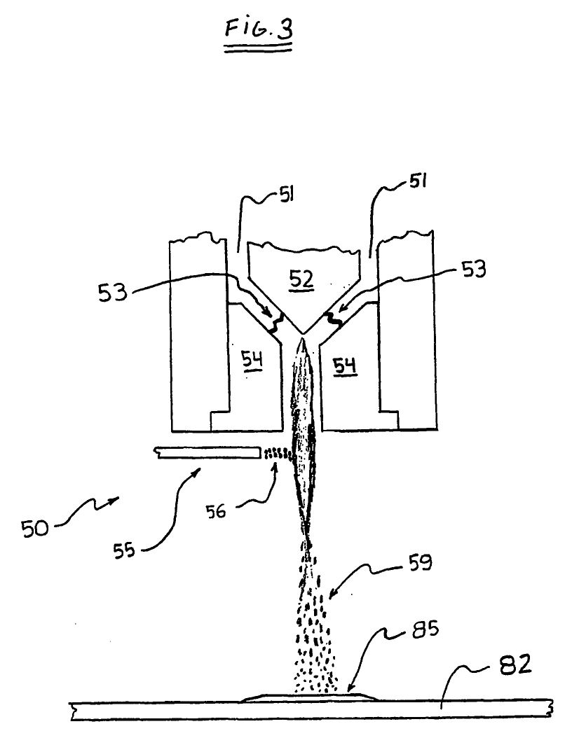

The present targets are formed by plasma spraying molten (i.e., heat softened) material onto a target backing. As is best illustrated in FIG. 3, a plasma gun 50 (or “jet”) communicates with a gas supply (not shown) from which plasma gas flows through a channel 51 leading past a cathode 52 and an anode 54. The plasma gas, which may comprise one or more different types of gas (e.g., argon, hydrogen, nitrogen, helium), flows past the cathode 52 and the anode 54. One or more electric arcs 53 are generated between the cathode 52 and the anode 54. These arcs 53 cause the gas to heat up and reach very high temperatures, which in turn results in gas dissociation and plasma formation. During this process, the rapid expansion of plasma gas causes a very hot stream of plasma to rapidly accelerate from the fixed interior volume of the plasma gun. Photocatalyst particles 56 are fed into this high temperature plasma stream, typically from a powder supply 55 mounted near the outlet of the plasma gun. This causes a molten stream of particles 59 to be accelerated toward the target backing 82. The molten material that accumulates on the target backing 82 forms a coating of target material 85. During plasma spraying, the target backing 82 is rotated and translated laterally in a back and forth manner to assure the target base 82 is uniformly coated with target material 85.

The present photocatalytic targets can be produced in such a way that they have very low electrical resistivity. In fact, favored production methods yield photocatalytic targets that have such low resistivity/high conductivity, that they can be used for DC magnetron sputtering and other high power sputtering processes (i.e., sputtering processes that involve power levels in excess of 35 kW). Thus, in a particularly preferred embodiment, there is provided a process for the preparation of sputtering targets that comprise substoichiometric titanium oxide, TiOₓ, where x is less than two. The process yields targets having an electrical resistivity of less than 0.5 ohm.cm.

The process comprises plasma spraying titanium dioxide onto a target backing. The plasma spraying can be performed in the manner discussed above with reference to FIG. 3. The titanium dioxide particles preferably have an average particle size in the range of about 1-60 micrometers, most preferably in the range of about 1-20 micrometers. If the particle size greatly exceeds 60 micrometers, then the particles are less likely to become completely molten. On the other hand, if the particle size is far less than 1 micrometer, then the powder is more likely to be dispersed in the spraying chamber instead of being uniformly deposited on the target base.

As noted above, the plasma spraying is carried out under conditions that result in the target base being coated with substoichiometric titanium oxide, TiOₓ, where x is less than two. The titanium dioxide particles are fed into a plasma flame, which preferably has a temperature of at least about 2000° C. The action of the plasma flame on the titanium dioxide causes the titanium dioxide to lose some oxygen atoms from its lattice. The plasma spraying is advantageously performed in a processing atmosphere that is substantially free of oxygen (i.e., free of oxygen and oxygen-containing compounds), other than that contained in the titanium dioxide being sprayed into the chamber. When stoichiometric titanium dioxide (i.e., TiO₂) is plasma sprayed under these conditions, it is converted into substoichiometric form (i.e., TiOₓ, where x is less than 2). Thus, plasma spraying under these conditions will yield targets comprising non-stoichiometric oxygen-deficient titanium oxide.

Argon can be used quite advantageously as a primary plasma gas in the present plasma spraying methods. It is to be understood that use herein of the term “primary plasma gas” is meant to refer to the gas that is present in the greatest concentration in a processing environment. Argon is a desirable plasma gas since it readily forms a plasma. In fact, even if a secondary plasma gas is used with argon during the actual plasma spraying, it may be preferable to start up the plasma using pure argon, since argon so easily forms a plasma. Argon is also inert to virtually all spray materials. Moreover, it tends to be less degenerative to plasma spraying hardware (e.g., the nozzle) than other gases.

While argon tends to be the favored primary plasma gas, in many cases it is desirable to use argon with a secondary plasma gas that will increase plasma energy. Use herein of the term “secondary plasma gas” is meant to refer to a gas that is present in a processing environment in a lesser concentration than the primary plasma gas. For example, it is desirable to achieve particle temperatures on the order of at least 2000° C., and more preferably above 2500° C. In order to produce such high temperatures, it is preferable to use hydrogen and/or helium as a secondary plasma gas.

Particularly favored plasma spraying methods yield titania targets having electrical resistivities as low as 0.02 ohm.cm. Thus, they can be sputtered at high power levels using conventional D.C. power supplies. In fact, they can be sputtered at power levels of up to 100 kW. In such methods, plasma spraying is carried out in a processing atmosphere that results in the target base being coated with substoichiometric titanium oxide, TiOₓ, where x is below two and is generally in the range of about 1.55 to about 1.95. In this method, it is desirable to plasma spray in a processing atmosphere that comprises a reducing gas. Hydrogen, for example, is a powerful reducing agent that can be used quite advantageously as a secondary plasma gas. Use of a reducing gas is particularly preferred when the plasma sprayed titania is desirably highly oxygen deficient.

When the substoichiometric titanium oxide is coated onto the target base, it can be solidified under conditions that prevent it from regaining oxygen and reconverting to TiO₂. This is done by minimizing the amount of oxygen and oxygen-containing compounds that are present in the plasma-spraying environment, while cooling the target base to quench the titanium oxide in substoichiometric form. For example, the target base can be provided with a water-cooling system (e.g., a series of water lines through which controlled-temperature water can be circulated). This is preferable in producing targets that have low resistivity, as the stoichiometric form of titanium dioxide tends to be less conductive than substoichiometric forms.

The disclosed plasma spraying methods yield photocatalytic targets that are highly uniform in electrical conductivity/resistivity. This is best understood with reference to FIG. 2. By plasma spraying a target under the conditions discussed above, the conductivity of the target material adjacent the outer surface of the target (i.e., the outermost target material 85A) ends up being substantially the same as that adjacent the backing tube (i.e., the innermost target material 85B). This allows substantially all of the target material 85 to be stably sputtered at very high rates (i.e., at high power levels).

To the contrary, targets formed by hot-pressing methods would not typically exhibit such uniform resistivity. For example, a target formed by hot-pressing in a reducing atmosphere (e.g., a processing atmosphere comprising hydrogen) would tend not to be uniformly reduced. The reducing gas would likely have less impact on the innermost target material 85B, than it would on the outermost target material 85A. As a result, the innermost target material 85B would contain more oxygen than the outermost target material 85A. Thus, the inner portions of the target would be expected to be less conductive and more difficult to sputter at high power levels than the outer portions of the target. To the contrary, the present plasma-sprayed targets are ideally suited for high power sputtering applications.

The present targets do not require expensive arc-diverter systems, D.C. switching power supplies, or Twin-Mag Systems where two targets are sequentially used as anode and cathode with a mid-frequency power supply. These targets also have no special gas control system requirements. Accordingly, it is anticipated that the present targets will be suitable for use in most existing sputtering facilities without the need for modification.

As noted above, particularly preferred embodiments of the present invention involve titanium oxide sputtering targets. These targets do not suffer significantly from arcing problems because titanium oxide (i.e., titania) has a higher melting point than titanium metal. Metallic titanium suffers from the so-called “vapor arcing” problem as a result of its low melting point. Thus, the relatively high melting point of titania assures that if arcing does occur during sputtering, there will be little attendant damage to the target.

The photocatalytic targets of the invention have very useful applications. For example, they can be used to deposit surprisingly efficient photocatalytic films. That is, they can be used to deposit films having high photoactivity levels, even at very small thicknesses. These targets are even more desirable when formed in accordance with the present disclosure so as to have low electrical resistivity. This allows efficient photocatalytic films to be deposited at very high sputtering rates. Thus, a further aspect of the invention provides a method of depositing photocatalytic coatings using the present targets. The method comprises providing a sputtering target produced by plasma spraying photocatalyst particles that are free of inert particle treatment onto a target base. The resulting target is sputtered to deposit a photocatalytic coating onto a substrate (e.g., a sheet of glass). The invention also provides coated substrates that are produced by this method.

1. A method of producing a sputtering target adapted for the deposition of photocatalytic coatings, the method comprising plasma spraying photocatalyst particles that are free of inert particle treatment onto a target base.

2. The method of claim 1 wherein the photocatalyst particles are substantially free of inorganic coating.

3. The method of claim 1 or 2 wherein the particles are formed from a photocatalyst that has an unmodified crystal lattice.

4. The method of any one of claims 1 to 3 wherein the photocatalyst particles comprise an oxide of a metal selected from the group consisting of titanium, iron, silver, copper, tungsten, aluminum, zinc, strontium, palladium, gold, platinum, nickel, and cobalt.

5. The method of any one of claims 1 to 4 wherein the photocatalyst particles comprise titanium oxide.

6. The method of any one of claims 1 to 5 wherein the photocatalyst particles comprise rutile and/or anatase phase titanium dioxide.

7. The method of any one of claims 1 to 5 wherein the photocatalyst particles comprise anatase phase titanium dioxide.

8. The method of any one of claims 1 to 7 wherein the plasma spraying is carried out under conditions that result in the target base being coated with substoichiometric titanium oxide, TiOₓ, where x is less than 2.

9. The method of claim 8 wherein the photocatalyst particles are fed into a plasma flame having a temperature of at least about 2000° C.

10. The method of claim 8 wherein the plasma spraying is carried out in a processing atmosphere that results in the target base being coated with substoichiometric titanium oxide, TiOₓ, where x is between 1.55 and 1.95.

11. The method of claim 10 wherein said processing atmosphere comprises a reducing gas.

12. The method of claim 11 wherein the reducing gas is hydrogen.

13. The method of claim 11 or 12 wherein said processing atmosphere comprises argon as a primary gas, said hydrogen being a secondary gas.

14. The method of any one of claims 1 to 13 wherein the photocatalyst particles have an average particle size in the range of 1-60 micrometers.

15. A sputtering target produced by the method of claims 1 to 14.

16. A method of depositing photocatalytic coatings, the method comprising sputtering the target of claim 15 to deposit a photocatalytic coating onto a substrate.

17. A coated substrate produced by the method of claim 16.

18. A sputtering target adapted for the deposition of photocatalytic coatings, the target being produced by a method comprising plasma spraying photocatalyst particles that are free of inert particle treatment onto a target base to form a coating thereon.

19. The sputtering target of claim 18 wherein said coating has an electrical resistivity that is substantially uniform between the target base and an outer surface of said coating.

20. The sputtering target of claim 18 or 19 wherein said coating comprises titanium oxide having an electrical resistivity of less than about 0.5 ohm.cm.

21. The sputtering target of any one of claims 18 to 20 wherein said coating comprises titanium oxide having an electrical resistivity of about 0.02 ohm.cm.

22. A method of depositing photocatalytic coatings, the method comprising:
a) providing a sputtering target produced by a method comprising plasma spraying photocatalyst particles that are free of inert particle treatment onto a target base; and
b) sputtering said target to deposit a photocatalytic coating onto a substrate.

23. A coated substrate produced by a method comprising:
a) providing a sputtering target produced by a method comprising plasma spraying photocatalyst particles that are free of inert particle treatment onto a target base; and
b) sputtering said target to deposit a photocatalytic coating onto a substrate.
